(19) United States
(12) Patent Application Publication
(10) Pub. No.: US 2026/0002437 A1
(43) Pub. Date: Jan. 1, 2026

(54) PROFILE IDENTIFICATION FOR DOWNHOLE POSITIONING USING NON-CONTACTING ULTRASONIC WAVES

(71) Applicant: Halliburton Energy Services, Inc., Houston, TX (US)

(72) Inventors: Jing JIN, Singapore (SG); Zeqing SUN, Singapore (SG); Xiang WU, Singapore (SG); Chong Yong KOH, Singapore (SG)

(73) Assignee: Halliburton Energy Services, Inc., Houston, TX (US)

(21) Appl. No.: 18/759,151

(22) Filed: Jun. 28, 2024

(51) Int. Cl. E21B 47/085

(52) U.S. Cl. CPC E21B 47/085

(57) ABSTRACT

Described herein are systems and techniques for improving deployment accuracies of wellbore tools. Systems and techniques of the present disclosure may transmit acoustic waves and sense reflections of those acoustic waves as a tool is deployed in a wellbore. Data associated with the sensed acoustic waves may be analyzed to identify features of the wellbore that correspond to specific locations of the wellbore. The location and/or velocity of the tool may be monitored when the tool is deployed. Deployment of the tool may be controlled until the tool reaches a target wellbore location. Once the tool is located at the target wellbore location, data from the tool or commands sent via the tool may be used to control one or more pieces of wellbore equipment such that the wellbore can be managed according to wellbore management requirements.

### TECHNICAL FIELD

The present disclosure is generally directed to identifying movement of a wellbore tool more accurately. More specifically, the present disclosure is directed to improving how accurately a wellbore tool can be deployed to a location of a wellbore.

### BACKGROUND

A wellbore or borehole is a hole that is drilled in the ground, often for the purpose of extracting substances (e.g., oil, natural gas, or water) or to provide substances into subterranean structures (e.g., carbon dioxide or hydraulic fracturing fluids). During virtually any phase of wellbore development, tools may be deployed in a wellbore such that one or more different operations may be performed in the wellbore. In certain instances, the current location of a wellbore tool may need to be controlled such that the tool can perform a wellbore management operation.

### BRIEF DESCRIPTION OF THE DRAWINGS

In order to describe the manner in which the features and advantages of this disclosure can be obtained, a more particular description is provided with reference to specific implementations thereof which are illustrated in the appended drawings. Understanding that these drawings depict only exemplary implementations of the disclosure and are not therefore to be considered to be limiting of its scope, the principles herein are described and explained with additional specificity and detail through the use of the accompanying drawings in which:

FIG. 1A is a schematic diagram of an example logging while drilling wellbore operating environment, in accordance with various aspects of the subject technology.

FIG. 1B is a schematic diagram of an example downhole environment having tubulars, in accordance with various aspects of the subject technology.

FIG. 2 illustrates a wellbore tool that emits acoustic waves as it moves along a wellbore, in accordance with various aspects of the subject technology.

FIG. 3 illustrates a graph of series of pulses that may have been received by an acoustic transceiver after a respective acoustic pulse was transmitted from the acoustic transceiver, in accordance with various aspects of the subject technology.

FIG. 4 includes a first curve that corresponds to an actual profile of one or more wellbore features and FIG. 4 includes a second curve corresponds to an interpreted profile of the one or more wellbore features, in accordance with various aspects of the subject technology.

FIG. 5 illustrates graphs of three different pulses of acoustic energy collected by an acoustic sensing device when the inner diameter of a wellbore casing varies, in accordance with various aspects of the subject technology.

FIG. 6 illustrates actions that may be performed when an acoustic sensing device is deployed in a wellbore, in accordance with various aspects of the subject technology.

FIG. 7 illustrates an example computing device architecture which can be employed to perform any of the systems and techniques described herein.

### DETAILED DESCRIPTION

Various aspects of the disclosure are discussed in detail below. While specific implementations are discussed, it should be understood that this is done for illustration purposes only. A person skilled in the relevant art will recognize that other components and configurations may be used without parting from the spirit and scope of the disclosure.

Additional features and advantages of the disclosure will be set forth in the description which follows, and in part will be obvious from the description, or can be learned by practice of the principles disclosed herein. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

It will be appreciated that for simplicity and clarity of illustration, where appropriate, reference numerals have been repeated among the different figures to indicate corresponding or analogous compounds. In addition, numerous specific details are set forth in order to provide a thorough understanding of the methods and apparatus described herein. However, it will be understood by those of ordinary skill in the art that the methods and apparatus described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the present disclosure.

Conventional methods for identifying the location of a tool deployed in a wellbore include measuring the length of a cable used to lower the tool into the wellbore and include counting a number of revolutions of a wheel that rolls along a surface of the wellbore. Each of these methods have limited accuracy. In the first instance, a deployment cable may stretch when it is deployed in the wellbore. In the second instance, wheels used to measure distance may slip or not roll as designed. As such, each of these techniques suffer from limited accuracy. For example, in an instance when 2 km of cable has been used to deploy a tool and when that cable stretches up to about 5% of its length, a cable that is 2 km long could stretch to a length of 2100 meters when deployed in the wellbore.

Methods of the present disclosure may identify locations where a wellbore tool is deployed to an accuracy that is greater than conventional methods can achieve. Accurately delivering a wellbore tool to a specific location in the wellbore is important because the wellbore tool may be deployed to perform functions that require the tool to be within a threshold distance of the specific location.

Apparatus of the present disclosure may track movement of the tool as the tool moves along a wellbore or may control a deployment velocity of the tool. Methods and apparatus of the present disclosure may control the descent of a wellbore tool to a target location of the wellbore according to a deployment profile.

Described herein are systems, apparatuses, processes (also referred to as methods), and computer-readable media (collectively referred to as “systems and techniques”) for more accurately deploying tools in a wellbore. Examples of the systems and techniques described herein are illustrated in the figures that follow.

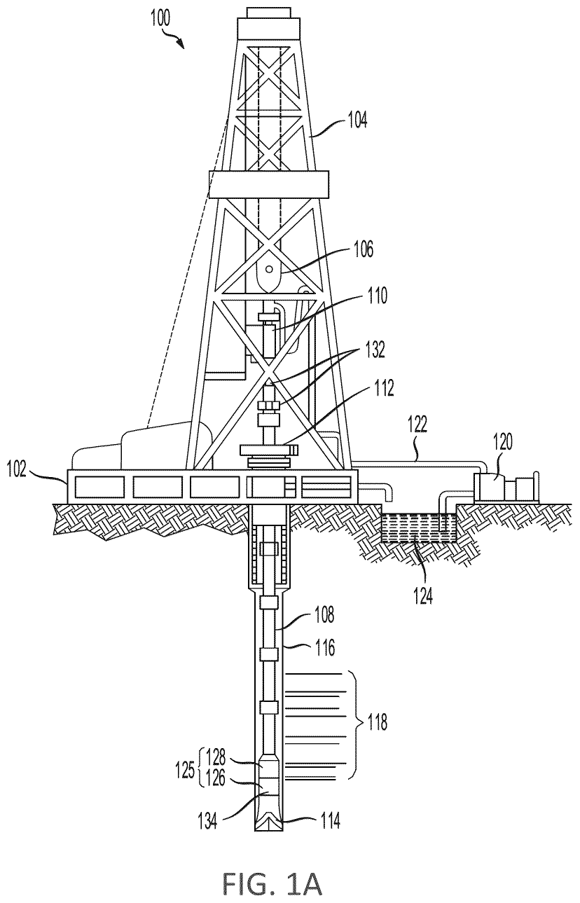

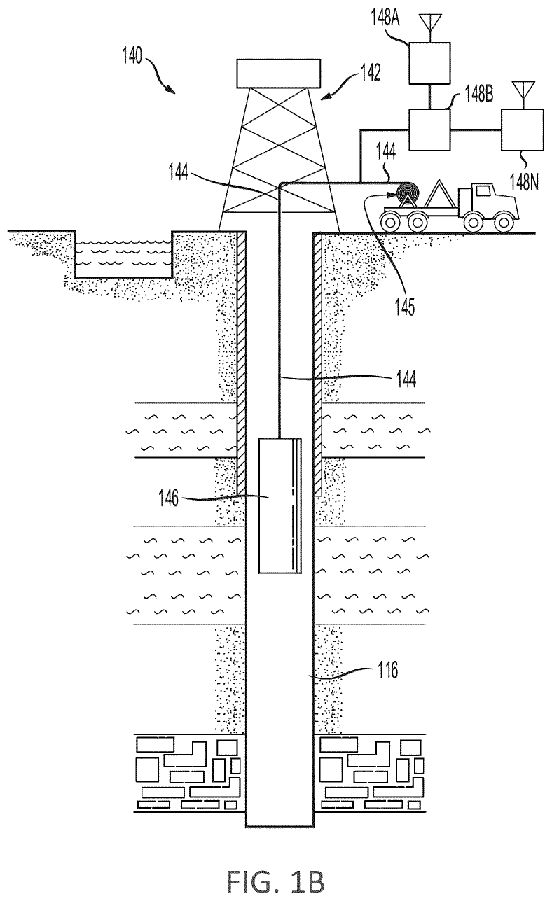

FIG. 1A is a schematic diagram of an example logging while drilling wellbore operating environment, in accordance with various aspects of the subject technology. The drilling arrangement shown in FIG. 1A provides an example of a logging-while-drilling (commonly abbreviated as LWD) configuration in a wellbore drilling scenario 100. The LWD configuration can incorporate sensors (e.g., EM sensors, seismic sensors, gravity sensor, image sensors, etc.) that can acquire formation data, such as characteristics of the formation, components of the formation, etc. For example, the drilling arrangement shown in FIG. 1A can be used to gather formation data through an electromagnetic imager tool (not shown) as part of logging the wellbore using the electromagnetic imager tool. The drilling arrangement of FIG. 1A also exemplifies what is referred to as Measurement While Drilling (commonly abbreviated as MWD) which utilizes sensors to acquire data from which the wellbore's path and position in three-dimensional space can be determined. FIG. 1A shows a drilling platform 102 equipped with a derrick 104 that supports a hoist 106 for raising and lowering a drill string 108. The hoist 106 suspends a top drive 110 suitable for rotating and lowering the drill string 108 through a well head 112. A drill bit 114 can be connected to the lower end of the drill string 108. As the drill bit 114 rotates, it creates a wellbore 116 that passes through various subterranean formations 118. A pump 120 circulates drilling fluid through a supply pipe 122 to top drive 110, down through the interior of drill string 108 and out orifices in drill bit 114 into the wellbore. The drilling fluid returns to the surface via the annulus around drill string 108, and into a retention pit 124. The drilling fluid transports cuttings from the wellbore 116 into the retention pit 124 and the drilling fluid's presence in the annulus aids in maintaining the integrity of the wellbore 116. Various materials can be used for drilling fluid, including oil-based fluids and water-based fluids.

Logging tools 126 can be integrated into the bottom-hole assembly 125 near the drill bit 114. As drill bit 114 extends into the wellbore 116 through the formations 118 and as the drill string 108 is pulled out of the wellbore 116, logging tools 126 collect measurements relating to various formation properties as well as the orientation of the tool and various other drilling conditions. The logging tool 126 can be applicable tools for collecting measurements in a drilling scenario, such as the electromagnetic imager tools described herein. Each of the logging tools 126 may include one or more tool components spaced apart from each other and communicatively coupled by one or more wires and/or other communication arrangement. The logging tools 126 may also include one or more computing devices communicatively coupled with one or more of the tool components. The one or more computing devices may be configured to control or monitor a performance of the tool, process logging data, and/or carry out one or more aspects of the methods and processes of the present disclosure.

The bottom-hole assembly 125 may also include a telemetry sub 128 to transfer measurement data to a surface receiver 132 and to receive commands from the surface. In at least some cases, the telemetry sub 128 communicates with a surface receiver 132 by wireless signal transmission (e.g., using mud pulse telemetry, EM telemetry, or acoustic telemetry). In other cases, one or more of the logging tools 126 may communicate with a surface receiver 132 by a wire, such as wired drill pipe. In some instances, the telemetry sub 128 does not communicate with the surface, but rather stores logging data for later retrieval at the surface when the logging assembly is recovered. In at least some cases, one or more of the logging tools 126 may receive electrical power from a wire that extends to the surface, including wires extending through a wired drill pipe. In other cases, power is provided from one or more batteries or via power generated downhole.

Collar 134 is a frequent component of a drill string 108 and generally resembles a very thick-walled cylindrical pipe, typically with threaded ends and a hollow core for the conveyance of drilling fluid. Multiple collars 134 can be included in the drill string 108 and are constructed and intended to be heavy to apply weight on the drill bit 114 to assist the drilling process. Because of the thickness of the collar's wall, pocket-type cutouts or other type recesses can be provided into the collar's wall without negatively impacting the integrity (strength, rigidity and the like) of the collar as a component of the drill string 108.

FIG. 1B is a schematic diagram of an example downhole environment having tubulars, in accordance with various aspects of the subject technology. In this example, an example system 140 is depicted for conducting downhole measurements after at least a portion of a wellbore has been drilled and the drill string removed from the well. An electromagnetic imager tool (not shown) can be operated in the example system 140 shown in FIG. 1B to log the wellbore. A downhole tool is shown having a tool body 146 in order to carry out logging and/or other operations. For example, instead of using the drill string 108 of FIG. 1A to lower the downhole tool, which can contain sensors and/or other instrumentation for detecting and logging nearby characteristics and conditions of the wellbore 116 and surrounding formations, a wireline conveyance 144 can be used. The tool body 146 can be lowered into the wellbore 116 by wireline conveyance 144. The wireline conveyance 144 can be anchored in the drill rig 142 or by a portable means such as a truck 145. The wireline conveyance 144 can include one or more wires, slicklines, cables, and/or the like, as well as tubular conveyances such as coiled tubing, joint tubing, or other tubulars. The downhole tool can include an applicable tool for collecting measurements in a drilling scenario, such as the electromagnetic imager tools described herein.

The illustrated wireline conveyance 144 provides power and support for the tool, as well as enabling communication between data processors 148A-N on the surface. In some examples, wireline conveyance 144 can include electrical and/or fiber optic cabling for carrying out communications. The wireline conveyance 144 is sufficiently strong and flexible to tether the tool body 146 through the wellbore 116, while also permitting communication through the wireline conveyance 144 to one or more of the processors 148A-N, which can include local and/or remote processors. The processors 148A-N can be integrated as part of an applicable computing system, such as the computing device architectures described herein. Moreover, power can be supplied via wireline conveyance 144 to meet power requirements of the tool. For slickline or coiled tubing configurations, power can be supplied downhole with a battery or via a downhole generator.

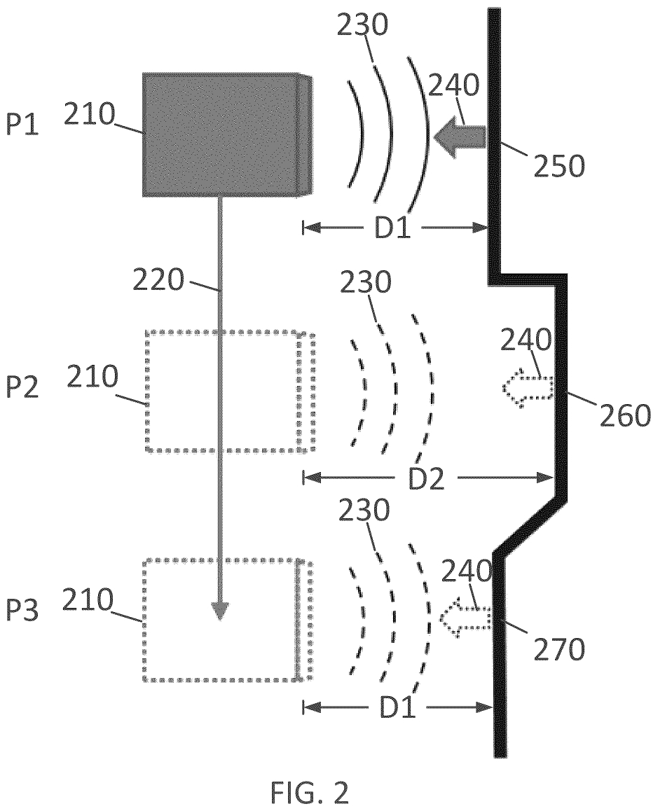

FIG. 2 illustrates a wellbore tool that emits acoustic waves as it moves along a wellbore. FIG. 2 includes wellbore tool 210 that emits acoustic waves 230 at different moments in time. These emissions or transmission of acoustic waves may be performed at collection points (P1, P2, and P3). As tool 210 moves down a wellbore (e.g., in a casing or tube) along vector 220, it may transmit pulses of acoustic energy (acoustic waves) 230 towards features of the wellbore. For example, acoustic waves 230 may be transmitted toward an inner portion of a wellbore casing, maybe transmitted toward a tube deployed in the wellbore, or may be transmitted toward some other structure of the wellbore (e.g., a valve or a collar that couples two pieces of the wellbore casing together). In certain instances, these acoustic waves may be transmitted at one or more selected frequencies or frequency range (e.g., one or more frequencies in the ultrasonic range of frequencies).

Once an acoustic wave 230 is transmitted by tool 210, it will travel until it impacts a surface and a portion of energy included in the acoustic wave may reflect back towards tool 210 as indicated by arrows 240. The speed at which these acoustic waves travel may correspond to the speed of sound through a fluid that surrounds tool 210. Because of this, data may be collected regarding the shape of features that acoustic waves 230 reflect off. Features 250, 260, and 270 of FIG. 2 may correspond to the shape of internal surfaces of a wellbore casing. Note that the distance separating tool 210 and feature 250 at point P1 and the distance separating tool 210 and feature 260 at point P3 both corresponds to a first distance D1. Note also that distance D2 (the distance separating tool 210 and feature 260 at point P2) is nearly twice the length of distance D1.

Since the time it takes for acoustic energy to move from tool 210 to a wellbore surface (e.g., surfaces of features 250, 260, or 270) may be measured by measuring a round trip acoustic wave travel time. Changes in travel times of acoustic waves may be used to identify specific features of a wellbore. In instances when a mapping of such features exists, a current location of wellbore tool 210 may be identified. Such round-trip travel times may be referred to as arrival times or arrival times of primary acoustic energy reflections.

Acoustic energy may be transmitted and received by any type of acoustic transmitter, receiver, transducer, or transceiver known in the art. In an instance when such a transducer scans a section of tubing or casing, changes in an inner radius r(z) of that tubing or casing affect the arrival time of a reflected acoustic signal. Distances, including, distances D1 and D2 illustrated in FIG. 2 may be represented by the term y(z) and inner radius r(z) may be expressed by the formula r(z)=y(z)+d, where d is the transducer's offset from a center line of the tubing or casing. Here, z is the relative position of the data collecting points P1, P2, and P3. A measure of z is not necessarily an absolute position in terms of depth from the ground's surface.

The first reflection's arrival time Tₐ(z) at each data collection point (P1, P2, and P3) can be calculated. Arrival time Tₐ(z) may be proportional to y(z) with a constant factor (or reference factor) of k when two assumptions are true: 1. When the wave propagation direction is aligned with the tubing or casing's radial direction (e.g., when a sidewall of the tubing or casing is perpendicular to an acoustic transceiver of wellbore tool 210); and 2. At times when any diffraction of reflected acoustic waves is negligible (e.g., less than a threshold level). Since acoustic waves travel from wellbore tool 210 to the casing/tubing wall (e.g., at features 250, 260, and 270) and back at the speed of sound through the fluid medium that separates wellbore tool 210 from casing or tubing surfaces and back.

When k corresponds to a distance D1 and distance D2 is 1.8 times D1, then arrival times associated with distance D2 will be 1.8 time longer than arrival times associated with distance D1. In such an instance D1=k=2/c, where c is the wave velocity in the fluid medium that separates wellbore tool 210 from the wall of the casing. When drilling mud fills the spaces between wellbore tool 210 and the wall of the casing/tubing, wave velocity c corresponds to the speed of sound moving through the drilling mud. Distances separating an acoustic transceiver and the wall of a casing or tube within which the acoustic transceiver is deployed may be measured in relative terms instead of being measured in units of distance (e.g., inches or centimeters) or in units of time.

In an instance when a wellbore includes 30-foot sections of casing that are each joined together by respective couples and when acoustic wave travel time is used to identify where each collar is located: a first collar would be located at a location of 30 feet, a second collar would be located at a location of 60 feet, and so on (e.g., collar number 100 would be located at a location of 3000 feet). As such, by counting a number of collars that the wellbore tool has passed, a current location of the wellbore tool may be identified. More than one type of feature may be identified as the wellbore tool moves along the wellbore. A mapping that cross-references location with wellbore features may be referenced by a computer when that computer tracks the location of the wellbore tool. As such, by comparing one or more features as they are identified with a mapping of wellbore features would allow the computer to identify a current location of the wellbore tool to a greater accuracy than other techniques. Time differences may also be used to identify the velocity of the wellbore tool. For example, when the wellbore tool takes 1 minute to move from one collar to the next collar and those collars are separated by 30 feet, the velocity of the wellbore tool would be 30 feet per minute. In certain instances, the tool may be deployed at a first velocity and as the tool approaches a target location of the wellbore, this deployment velocity may be reduced. The tool may be deployed according to a deployment profile and this deployment profile may dictate that the tool arrives at the target location according to a dampening profile. Such a dampening profile may correspond to an overdamped or critically damped such that the tool does not overshoot (e.g., move passed) the target location.

While in some instances, acoustic waves may be used just to identify general changes in distance, acoustic waves may be used to generate images of wellbore structures in ways similar to the way in which an ultrasonic imaging device operates. A resolution capable of generating images from collected data may not be necessary to place a wellbore tool within a threshold distance of a target location of the wellbore.

Each different type of wellbore feature may be associated with a particular pattern or signature. For example, a casing of a first diameter may have a first pattern or signature, a casing of a second diameter may have a second pattern or signature, and a collar may have a third pattern or signature. Signatures may also be used to identify other features of a wellbore, for example, such signatures may be used to identify the location of valves in the wellbore, the presence of tubes in the wellbore, a turning radius of the wellbore, or may be used to identify the location of other wellbore structures.

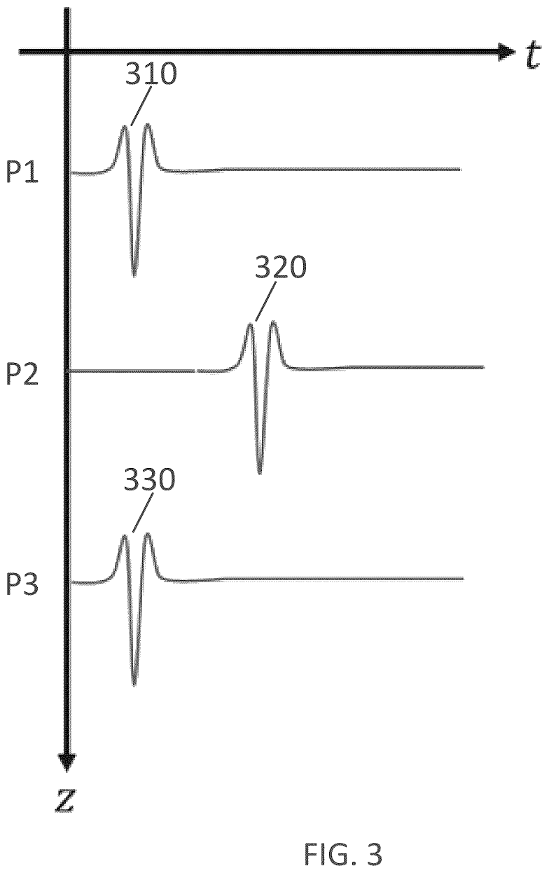

FIG. 3 illustrates a graph of series of pulses that may have been received by an acoustic transceiver after a respective acoustic pulse was transmitted from the acoustic transceiver. FIG. 3 includes a horizontal axis of arrival time ‘t’ and a vertical axis of relative distance ‘z.’ FIG. 3 includes signals or pluses 310, 320, and 330 received by wellbore tool 210 at locations P1, P2, and P3 along a wellbore. Since the arrival times of pulse 310 and 330 are the same, distances separating the wellbore tool 210 and the casing wall (or other wellbore structure) are the same (e.g., distance D1). Furthermore, since the arrival time of pulse 320 is larger than the arrival times of pulses 310 and 330, the distance separating wellbore tool 210 and casing (or other wellbore structure) at point P2 is greater than the distance separating wellbore tool 210 and the casing (or other wellbore structure) at points P1 and P3.

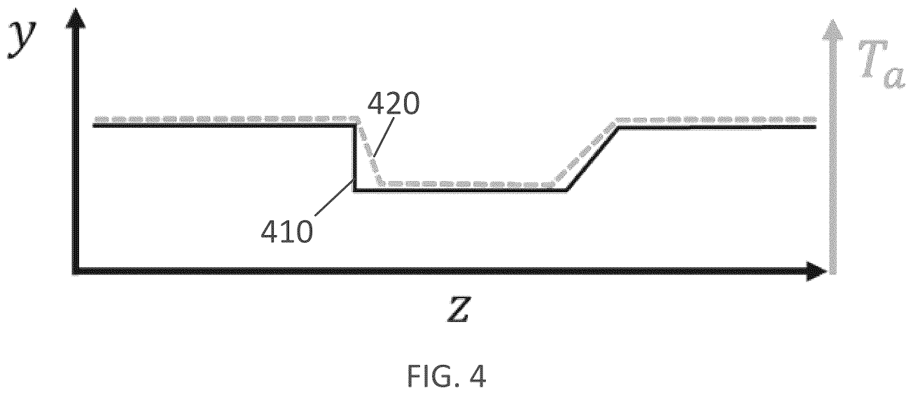

FIG. 4 includes a first curve that corresponds to an actual profile of one or more wellbore features and FIG. 4 includes a second curve corresponds to an interpreted profile of the one or more wellbore features. Here, curve 410 of FIG. 4 shows the profile of the known shape, and curve 420 of FIG. 4 shows the interpreted profile of this shape. Axis z of FIG. 4 may correspond to locations along a wellbore casing and axes y or Tₐ of FIG. 4 may respectively correspond to a separation distance and measured arrival time.

The differences in arrival times may correspond to a target profile or signature of timing differences. In an instance when a measured arrival time Tₐ(z) and a known target profile y(z) corresponds to some shape of a wellbore casing or other wellbore feature, matching algorithms may be used to identify an accurate location of a wellbore tool relative to a particular position of a profiled shape. An example of such a matching algorithm is a cross-correlation function. Because of this, to determine the location of the wellbore tool, the wave velocity c does not need to be known. The changes in arrival times illustrated in respect to FIG. 3 may be used to identify that timing differences between pulses 310, 320, and 330 correspond to the shape of curve 420 of FIG. 4.

For positioning, the mud's wave velocity c is not needed since the matching is conducted along the “z-axis,” and Tₐ and y may be associated with different scales. The proportional relationship between Tₐ(z) and y(z) may not be strictly satisfied at the steps or the slopes of the profile, because of diffractions and tilted reflecting surface. Such errors could be compensated in the matching algorithm, analytically, empirically, or using a machine-learning-based method.

Positioning resolution of a wellbore tool may depend on one or more of a frequency, a bandwidth, a pulse transmission rate, a sample rate, and an aperture size of an ultrasonic transceiver. The transducer design may have to be specifically tuned according to the profile feature size and an offset range of the ultrasonic transceiver. The tool may have one sensor or multiple sensors along an azimuthal direction. The sensors may be fixed on the tool, or they may rotate. Reflection data from multiple azimuthal directions may be used to identify non-axisymmetric profile features of a tube or casing. Even in instances when only axisymmetric profile features need to be identified, multiple sensors may be used to ensure the availability of data in case one sensor fails or is somehow blocked by debris. Any type of acoustic transmitter, transceiver, or receiver/sensor may be used in a wellbore tool. For example, a piezoelectric transceiver or a hydrophone may be used.

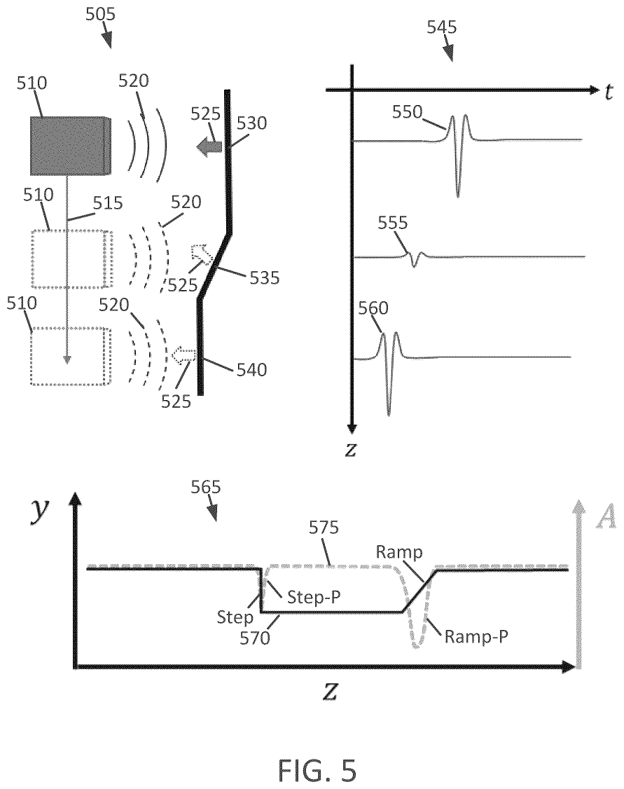

FIG. 5 illustrates graphs of three different pulses of acoustic energy collected by an acoustic sensing device when the inner diameter of a wellbore casing varies. FIG. 5 includes three different sets of images 505, 545, and 565. Image 505 shows the acoustic sensing device collecting data at different locations of the wellbore casing. Image 545 shows relative arrival times of different pulses received or sensed by an acoustic device of wellbore tool 510. Image 565 shows a pattern or curve 575 that may be used to identify that wellbore tool 510 has detected a feature that corresponds to known target profile of curve 570.

Image 505 of FIG. 5 shows an acoustic device that may be part of a wellbore tool 510 deployed in a wellbore along vector 515. Image 505 shows acoustic energy 520 being transmitted from the acoustic device and shows reflections 525 of that transmitted acoustic energy reflecting off internal surfaces of a wellbore casing at locations 530, 535, and 540 of the casing. Note that the reflections at wellbore casing location 530 and 540 are both directed back toward wellbore tool 510. This is because at locations 530 and 540, the casing is perpendicular to the direction that acoustic energy 520 travels toward the casing. At casing location 535, reflections 525 of the acoustic energy 520 back toward an inner part of the casing at an angle of about 45 degrees. The angled shape of the surface at casing location 535 results in pulse 555 of image 545 being smaller than pulses 550 and 560 of image 545 as discussed below. As such, the shape of the surface at casing location 535 results in a diffraction of reflected acoustic energy.

Image 545 includes three different pulses 550, 555, and 560 that were received when wellbore tool 510 was located respectively at locations 530, 535, and 540. Here again the timing of a received signal corresponds to a distance separating wellbore tool 510 and internal surfaces of casing. As such, pulse 550 has the longest arrival time, pulse 555 has a medium arrival time, and pulse 560 has the shortest arrival time. Since acoustic energy transmitted when the wellbore tool 510 was at locations 530 and 540 was reflected directly back to wellbore tool, pulses 550 and 560 have a greater magnitude (amplitude) than pulse 555. Pulse 555 corresponds to location 535 and is lower in magnitude than pulses 550 and 560, this is because the acoustic energy that reflects off the casing at location 535 is in a direction that does not directly face wellbore tool 510. Because of this, only a portion of the energy reflecting off casing location 535 is reflected back toward wellbore tool 510.

Image 565 of FIG. 5 illustrates curve 570 that corresponds to a known profile of a wellbore feature and curve 575 that may be indicative of the known profile of curve 570. While the profile of curve 570 is similar to the shape of curve 410 of FIG. 4, curve 575 is not similar to the shape of interpreted profile of curve 420. The profile curve 570 includes two different changes, a “Step” change and a “Ramp” change. Each of these different changes are associated with a pulse of curve 575, here the first pulse is labeled “Step-P” and the second pulse is labeled “Ramp-P.” The shape of a pattern or curve that may be used to identify that a wellbore tool has detected a particular feature may vary based on a number of factors. These factors may include a transmission repetition rate, a transmission frequency, a sample rate, a tool velocity, a tool-feature separation distance, or alignment of the tool relative to a shape (e.g., the step or ramp of curve 575) of a wellbore feature, for example.

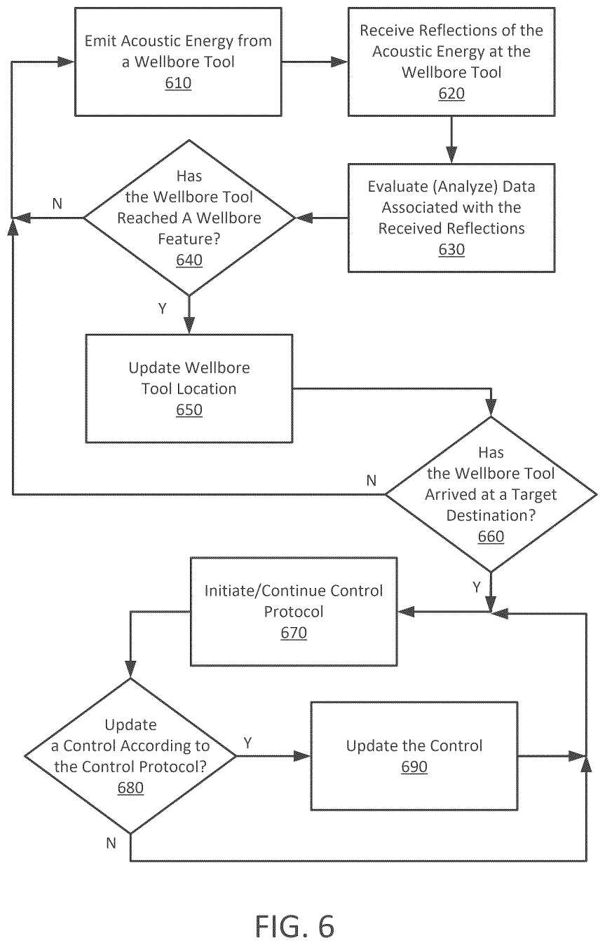

FIG. 6 illustrates actions that may be performed when an acoustic sensing device is deployed in a wellbore. At block 610 waves of acoustic energy may be emitted/transmitted by an acoustic device of a wellbore tool. As discussed in respect to FIGS. 2-5, these waves of acoustic energy move toward and reflect off objects before moving back toward acoustic sensors at the wellbore tool. Reflections of that acoustic energy may be received by the acoustic device of the wellbore tool at block 620.

At block 630 evaluations (analyses) may be made on data sensed by the acoustic device. These evaluations may be directed to identifying specific features of a wellbore. For example, these evaluations may analyze collected data to identify that the wellbore tool has reached feature 260 of FIG. 2 based on arrival times or round-trip travel times of acoustic waves changing as discussed in respect to FIGS. 2-3. This evaluation may also identify a profile or signature characteristic of wellbore features as discussed in respect to the interpreted shape of curve 420 of FIG. 4. Alternatively, or additionally, this evaluation may identify a profile or signature characteristic of curve 570 of FIG. 5. As such, evaluations performed at block 630, may identify that a shape of an interpreted feature should match the shape of a known feature to a threshold level as represented by curves 410 and 420 of FIG. 4. In certain instances, these evaluations may identify that one or more pulses like the pulses of curve 575 correspond to curve 570 based on a pattern of the pulses or a signal generated from received energy. Specific algorithms for matching interpreted patterns with known patterns may vary based on one or more factors. As mentioned above these factors may include a transmission repetition rate, a transmitted frequency, a sample rate, a tool velocity, a tool-feature separation distance, or alignment of the tool relative to a shape of a wellbore feature.

Based on the evaluations performed at block 630, a determination may be made at block 640 to identify whether the wellbore tool has reached a specific type of wellbore feature. For example, when the specific type of wellbore feature corresponds to a collar that holds lengths of casing together, repeated determinations that the wellbore tool is proximal to the wellbore casing may result in determination block identifying that the wellbore feature (e.g., a collar) has not been reached. When determination block 640 identifies that the wellbore feature (e.g., the collar) has not been reached, program flow may move back to block 610 where acoustic energy is emitted from the wellbore tool. When determination block 640 identifies that the wellbore tool has reached the wellbore feature, program flow may move to block 650 where the location of the wellbore tool is updated.

As mentioned above, more than one type of feature may be identified as the wellbore tool moves along the wellbore. A mapping that cross-references location with wellbore feature may be referenced by a computer when that computer tracks the location of the wellbore tool. Determination block 660 may identify whether the wellbore tool has reached a target destination. Here again, by comparing one or more features as they are identified with a mapping of wellbore features would allow the computer to identify a current location of the wellbore tool to a greater accuracy than other techniques. As such, changes in arrival times greater than a threshold level may be indicative of a specific type of wellbore feature.

When determination block 660 identifies that the wellbore tool has not arrived at the target location, program flow may move back to block 610 where additional acoustic energy is emitted from the wellbore tool. Actions performed at blocks 610 through 650 may be repeated until determination block 660 identifies that the wellbore tool has reached a target destination.

In an instance when a wellbore mapping indicates that the target destination corresponds to a valve located just below a fifth collar of a wellbore, data collected by an acoustic device of the wellbore tool may be evaluated and the location of the wellbore tool may be updated as the wellbore tool passes each respective collar. When the fifth collar is identified, additional evaluations may be performed to identify that the wellbore tool has reached the valve located just below the fifth collar. At this point motion of the wellbore tool may be halted.

When determination block 660 identifies that the wellbore tool has arrived at the target destination, movement of the tool may be stopped or paused. At block 670 control protocol may be initiated based on the tool being located at the target destination. This control protocol could involve various tasks, such as flow monitoring or controlling a flow of hydrocarbons. This control protocol may include a set of rules for controlling wellbore equipment. In one example, the protocol may dictate a specific flow rate for a given set of wellbore conditions and may identify whether a setting of piece of equipment should be changed to maintain or change that flow rate when wellbore conditions change.

The control protocol may dictate rules for managing equipment of the wellbore and may identify when a valve should be opened or closed or when a pump rate should be changed. A determination may be made at block 680 as to whether a control setting should be updated according to the protocol. When the control setting should not be updated, program flow may move back to block 670 where the control protocol may continue. When a determination is made at block 680 that the control setting should be updated, program flow may move to block 690 where the control setting is updated according to the control protocol. After block 690, program flow may move back to block 670 where the control protocol is continued.

The actions discussed in respect to FIG. 6 may be performed by an acoustic device that is communicatively coupled to a computer. This means that a computer may monitor flows of a wellbore, make determinations regarding how that those flows should be managed, and may control pieces of wellbore equipment (e.g., change a valve or pump setting or turn a pump or valve on or off). In some instances, this computer may perform the evaluations, determinations, and updates discussed in respect to blocks 630 through 690 of FIG. 6. In some instances, an operator may be queried by the computer as part of the control protocol.

Deploying the wellbore tool to a location within the wellbore may be essential for the equipment of the wellbore tool to be controlled according to the protocol. In one instance, the wellbore tool may have to be within a specific distance of the valve such that the valve can be controlled. For example, a valve may be controlled based on wireless data communications or a physical coupling. In another instance, the wellbore tool could collect data regarding a flow at the target location and determinations may be made regarding controlling that flow via a mechanism that is distant from the acoustic device. Being able to accurately locate a tool within a wellbore allows for the wellbore to be controlled more efficiently and/or effectively.

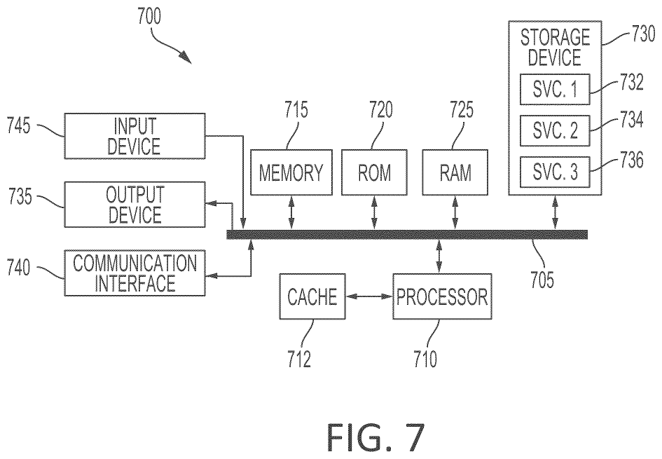

FIG. 7 illustrates an example computing device architecture which can be employed to perform any of the systems and techniques described herein. In some examples, the computing device 700 architecture can be integrated with tools described herein. The components of the computing device architecture 700 are shown in electrical communication with each other using a connection 705, such as a bus. The example computing device architecture 700 includes a processing unit (CPU or processor) 710 and a computing device connection 705 that couples various computing device components including the computing device memory 715, such as read only memory (ROM) 720 and random access memory (RAM) 725, to the processor 710.

The computing device architecture 700 can include a cache of high-speed memory connected directly with, in close proximity to, or integrated as part of the processor 710. The computing device architecture 700 can copy data from the memory 715 and/or the storage device 730 to the cache 712 for quick access by the processor 710. In this way, the cache can provide a performance boost that avoids processor 710 delays while waiting for data. These and other modules can control or be configured to control the processor 710 to perform various actions. Other computing device memory 715 may be available for use as well. The memory 715 can include multiple different types of memory with different performance characteristics. The processor 710 can include any general-purpose processor and a hardware or software service, such as service 1 732, service 2 734, and service 3 736 stored in storage device 730, configured to control the processor 710 as well as a special-purpose processor where software instructions are incorporated into the processor design. The processor 710 may be a self-contained system, containing multiple cores or processors, a bus, memory controller, cache, etc. A multi-core processor may be symmetric or asymmetric.

To enable user interaction with the computing device architecture 700, an input device 745 can represent any number of input mechanisms, such as a microphone for speech, a touch-sensitive screen for gesture or graphical input, keyboard, mouse, motion input, speech and so forth. An output device 735 can also be one or more of a number of output mechanisms known to those of skill in the art, such as a display, projector, television, speaker device, etc. In some instances, multimodal computing devices can enable a user to provide multiple types of input to communicate with the computing device architecture 700. The communications interface 740 can generally govern and manage the user input and computing device output. There is no restriction on operating on any particular hardware arrangement and therefore the basic features here may easily be substituted for improved hardware or firmware arrangements as they are developed.

Storage device 730 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 725, read only memory (ROM) 720, and hybrids thereof. The storage device 730 can include services 732, 734, 736 for controlling the processor 710. Other hardware or software modules are contemplated. The storage device 730 can be connected to the computing device connection 705. In one aspect, a hardware module that performs a particular function can include the software component stored in a computer-readable medium in connection with the necessary hardware components, such as the processor 710, connection 705, output device 735, and so forth, to carry out the function.

For clarity of explanation, in some instances the present technology may be presented as including individual functional blocks including functional blocks comprising devices, device components, steps or routines in a method implemented in software, or combinations of hardware and software.

In some instances, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can include hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific examples and aspects thereof, but those skilled in the art will recognize that the application is not limited thereto. Thus, while illustrative examples and aspects of the application have been described in detail herein, it is to be understood that the disclosed concepts may be otherwise variously embodied and employed, and that the appended claims are intended to be construed to include such variations, except as limited by the prior art. Various features and aspects of the above-described subject matter may be used individually or jointly. Further, examples and aspects of the systems and techniques described herein can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate examples, the methods may be performed in a different order than that described.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the method, algorithms, and/or operations described above. The computer-readable data storage medium may form part of a computer program product, which may include packaging materials.

The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

Methods and apparatus of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Such methods may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

In the above description, terms such as “upper,” “upward,” “lower,” “downward,” “above,” “below,” “downhole,” “uphole,” “longitudinal,” “lateral,” and the like, as used herein, shall mean in relation to the bottom or furthest extent of the surrounding wellbore even though the wellbore or portions of it may be deviated or horizontal. Correspondingly, the transverse, axial, lateral, longitudinal, radial, etc., orientations shall mean orientations relative to the orientation of the wellbore or tool.

The term “coupled” is defined as connected, whether directly or indirectly through intervening components, and is not necessarily limited to physical connections. The connection can be such that the objects are permanently connected or releasably connected. The term “outside” refers to a region that is beyond the outermost confines of a physical object. The term “inside” indicates that at least a portion of a region is partially contained within a boundary formed by the object. The term “substantially” is defined to be essentially conforming to the particular dimension, shape or another word that substantially modifies, such that the component need not be exact. For example, substantially cylindrical means that the object resembles a cylinder, but can have one or more deviations from a true cylinder.

The term “radially” means substantially in a direction along a radius of the object, or having a directional component in a direction along a radius of the object, even if the object is not exactly circular or cylindrical. The term “axially” means substantially along a direction of the axis of the object. If not specified, the term axially is such that it refers to the longer axis of the object.

Although a variety of information was used to explain aspects within the scope of the appended claims, no limitation of the claims should be implied based on particular features or arrangements, as one of ordinary skill would be able to derive a wide variety of implementations. Further and although some subject matter may have been described in language specific to structural features and/or method steps, it is to be understood that the subject matter defined in the appended claims is not necessarily limited to these described features or acts. Such functionality can be distributed differently or performed in components other than those identified herein. The described features and steps are disclosed as possible components of systems and methods within the scope of the appended claims.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative Statements of the disclosure include:

Statement 1: A method comprising: transmitting acoustic waves from an acoustic device as the acoustic device is deployed in a wellbore; sensing reflections of the transmitted acoustic waves; identifying that the acoustic device is at a target location of the wellbore based on one or more evaluations of data associated with the acoustic wave reflections; pausing deployment of the acoustic device based on the identification that the acoustic device is at the target location of the wellbore; and updating a control setting of wellbore equipment when the acoustic device is at the target location.

Statement 2: The method of statement 1, further comprising: identifying that the acoustic device has reached a first feature of the wellbore based on an analysis of a first portion of the data associated with the acoustic wave reflections; and identifying that the acoustic device has reached a second feature of the wellbore based on an analysis of a second portion of the data associated with the acoustic wave reflections.

Statement 3: The method of statement1 1 or 2, wherein a/the first and a/the second feature of the wellbore correspond to different locations of a wellbore map.

Statement 4: The method of statement any statements 1 through 3, further comprising: identifying a current location of the acoustic device; identifying that a velocity of the acoustic device should be reduced based on a deployment profile and the current location of the device; and reducing the velocity of the acoustic device based on the deployment profile.

Statement 5: The method of any of statements 1 through 4, further comprising: identifying a time difference associated with movement of the acoustic device from a first wellbore feature to a second wellbore feature; and identifying the velocity of the acoustic device based on the time difference and a distance separating the first wellbore feature and the second wellbore feature.

Statement 6: The method of any of statements 1 through 5, further comprising: identifying that a portion of the data associated with the acoustic wave reflections matches a pattern indicative of a wellbore feature located at the target location.

Statement 7: The method of any of statements 1 through 6, further comprising: identifying a first arrival time indicative of a first separation distance; identifying a second arrival time indicative of a second separation distance; an identifying that the acoustic device has reached the target location based on the first arrival time indicative of the first separation distance and the second arrival time indicative of the second separation distance corresponding to a wellbore feature located at the target location.

Statement 8: A system comprising one or more acoustic elements of an acoustic device that: transmit acoustic waves as the acoustic device is deployed in a wellbore, and sense reflections of the transmitted acoustic waves. This system may also include a memory; and one or more processors that execute instructions out of the memory to: identify that the acoustic device is at a target location of the wellbore based on one or more evaluations of data associated with the acoustic wave reflections, initiate one or more control functions that result in: the deployment of the acoustic device being paused based on the identification that the acoustic device is at the target location of the wellbore, and a control setting of wellbore equipment being updated when the acoustic device is at the target location.

Statement 9: The system of statement 8, wherein the one or more processors execute the instructions out of the memory to: identify that the acoustic device has reached a first feature of the wellbore based on an analysis of a first portion of the data associated with the acoustic wave reflections, and identify that the acoustic device has reached a second feature of the wellbore based on an analysis of a second portion of the data associated with the acoustic wave reflections.

Statement 10: The system of statement 8 or 9, wherein a/first and the second feature of a/the wellbore correspond to different locations of a wellbore map.

Statement 11: The system of any of statements 8 through 9, wherein the one or more processors execute the instructions out of the memory to: identify a current location of the acoustic device; identify that a velocity of the acoustic device should be reduced based on a deployment profile and the current location of the device; and initiate at least one of the one or more control functions to reduce the velocity of the acoustic device based on the deployment profile.

Statement 12: The system of any of statements 8 through 11, wherein the one or more processors execute the instructions out of the memory to identify a time difference associated with movement of the acoustic device from a first wellbore feature to a second wellbore feature, and identify the velocity of the acoustic device based on the time difference and a distance separating the first wellbore feature and the second wellbore feature.

Statement 13: The system of any of statements 8 through 12, wherein the one or more processors execute the instructions out of the memory to identify that a portion of the data associated with the acoustic wave reflections matches a pattern indicative of a wellbore feature located at the target location.

Statement 14, The system of statement 13, wherein the one or more processors execute the instructions out of the memory to identify a first arrival time indicative of a first separation distance; identify a second arrival time indicative of a second separation distance; identify that the acoustic device has reached the target location based on the first arrival time indicative of the first separation distance and the second arrival time indicative of the second separation distance corresponding to a wellbore feature located at the target location.

Statement 15: A non-transitory computer-readable storage medium having embodied thereon instructions executable by one or more processors to: initiate operation of an acoustic device that: transmits acoustic waves as the acoustic device is deployed in a wellbore, and senses reflections of the transmitted acoustic waves. Execution of the instructions by the one or more processors out of a memory may cause the one or more processors to identify that the acoustic device is at a target location of the wellbore based on one or more evaluations of data associated with the acoustic wave reflections; and initiate one or more control functions that result in: the deployment of the acoustic device being paused based on the identification that the acoustic device is at the target location of the wellbore, and a control setting of wellbore equipment being updated when the acoustic device is at the target location.

Statement 16: The non-transitory computer-readable storage medium of statement 15, wherein the one or more processors execute the instructions out of the memory to identify that the acoustic device has reached a first feature of the wellbore based on an analysis of a first portion of the data associated with the acoustic wave reflections, and identify that the acoustic device has reached a second feature of the wellbore based on an analysis of a second portion of the data associated with the acoustic wave reflections.

Statement 17: The non-transitory computer-readable storage medium of Statement 15 or 16, wherein a/the first and the second feature of the wellbore correspond to different locations of a wellbore map.

Statement 18: The non-transitory computer-readable storage medium of any of statements 15 through 17, wherein the one or more processors execute the instructions out of the memory to identify a current location of the acoustic device; identify that a velocity of the acoustic device should be reduced based on a deployment profile and the current location of the device; and initiate at least one of the one or more control functions to reduce the velocity of the acoustic device based on the deployment profile.

Statement 19: The non-transitory computer-readable storage medium of claim of any of statements 15 through 18, wherein the one or more processors execute the instructions out of the memory to identify a time difference associated with movement of the acoustic device from a first wellbore feature to a second wellbore feature; and identify the velocity of the acoustic device based on the time difference and a distance separating the first wellbore feature and the second wellbore feature.

Statement 20: The non-transitory computer-readable storage medium of any of statements 15 through 19, wherein the one or more processors execute the instructions out of the memory to identify that a portion of the data associated with the acoustic wave reflections matches a pattern indicative of a wellbore feature located at the target location.

What is claimed is:

1. A method comprising:
transmitting acoustic waves from an acoustic device as the acoustic device is deployed in a wellbore;
sensing reflections of the transmitted acoustic waves;
identifying that the acoustic device is at a target location of the wellbore based on one or more evaluations of data associated with the acoustic wave reflections;
pausing deployment of the acoustic device based on the identification that the acoustic device is at the target location of the wellbore; and
updating a control setting of wellbore equipment when the acoustic device is at the target location.

2. The method of claim 1, further comprising:
identifying that the acoustic device has reached a first feature of the wellbore based on an analysis of a first portion of the data associated with the acoustic wave reflections; and
identifying that the acoustic device has reached a second feature of the wellbore based on an analysis of a second portion of the data associated with the acoustic wave reflections.

3. The method of claim 2, wherein the first and the second feature of the wellbore correspond to different locations of a wellbore map.

4. The method of claim 3, further comprising:
identifying a current location of the acoustic device;
identifying that a velocity of the acoustic device should be reduced based on a deployment profile and the current location of the device; and
reducing the velocity of the acoustic device based on the deployment profile.

5. The method of claim 4, further comprising:
identifying a time difference associated with movement of the acoustic device from a first wellbore feature to a second wellbore feature; and
identifying the velocity of the acoustic device based on the time difference and a distance separating the first wellbore feature and the second wellbore feature.

6. The method of claim 1, further comprising:
identifying that a portion of the data associated with the acoustic wave reflections matches a pattern indicative of a wellbore feature located at the target location.

7. The method of claim 1, further comprising:
identifying a first arrival time indicative of a first separation distance;
identifying a second arrival time indicative of a second separation distance; and
identifying that the acoustic device has reached the target location based on the first arrival time indicative of the first separation distance and the second arrival time indicative of the second separation distance corresponding to a wellbore feature located at the target location.

8. A system comprising:
one or more acoustic elements of an acoustic device that:
transmit acoustic waves as the acoustic device is deployed in a wellbore, and
sense reflections of the transmitted acoustic waves;
a memory; and
one or more processors that execute instructions out of the memory to:
identify that the acoustic device is at a target location of the wellbore based on one or more evaluations of data associated with the acoustic wave reflections,
initiate one or more control functions that result in:
the deployment of the acoustic device being paused based on the identification that the acoustic device is at the target location of the wellbore, and
a control setting of wellbore equipment being updated when the acoustic device is at the target location.

9. The system of claim 8, wherein the one or more processors execute the instructions out of the memory to:
identify that the acoustic device has reached a first feature of the wellbore based on an analysis of a first portion of the data associated with the acoustic wave reflections, and
identify that the acoustic device has reached a second feature of the wellbore based on an analysis of a second portion of the data associated with the acoustic wave reflections.

10. The system of claim 9, wherein the first and the second feature of the wellbore correspond to different locations of a wellbore map.

11. The system of claim 10, wherein the one or more processors execute the instructions out of the memory to:
identify a current location of the acoustic device;
identify that a velocity of the acoustic device should be reduced based on a deployment profile and the current location of the device; and
initiate at least one of the one or more control functions to reduce the velocity of the acoustic device based on the deployment profile.

12. The system of claim 11, wherein the one or more processors execute the instructions out of the memory to:
identify a time difference associated with movement of the acoustic device from a first wellbore feature to a second wellbore feature, and
identify the velocity of the acoustic device based on the time difference and a distance separating the first wellbore feature and the second wellbore feature.

13. The system of claim 8, wherein the one or more processors execute the instructions out of the memory to:
identify that a portion of the data associated with the acoustic wave reflections matches a pattern indicative of a wellbore feature located at the target location.

14. The system of claim 8, wherein the one or more processors execute the instructions out of the memory to:
identify a first arrival time indicative of a first separation distance;
identify a second arrival time indicative of a second separation distance;
identify that the acoustic device has reached the target location based on the first arrival time indicative of the first separation distance and the second arrival time indicative of the second separation distance corresponding to a wellbore feature located at the target location.

15. A non-transitory computer-readable storage medium having embodied thereon instructions executable by one or more processors to:
initiate operation of an acoustic device that:
transmits acoustic waves as the acoustic device is deployed in a wellbore, and
senses reflections of the transmitted acoustic waves;
identify that the acoustic device is at a target location of the wellbore based on one or more evaluations of data associated with the acoustic wave reflections; and
initiate one or more control functions that result in:
the deployment of the acoustic device being paused based on the identification that the acoustic device is at the target location of the wellbore, and
a control setting of wellbore equipment being updated when the acoustic device is at the target location.

16. The non-transitory computer-readable storage medium of claim 15, wherein the one or more processors execute the instructions to:
identify that the acoustic device has reached a first feature of the wellbore based on an analysis of a first portion of the data associated with the acoustic wave reflections, and
identify that the acoustic device has reached a second feature of the wellbore based on an analysis of a second portion of the data associated with the acoustic wave reflections.

17. The non-transitory computer-readable storage medium of claim 16, wherein the first and the second feature of the wellbore correspond to different locations of a wellbore map.

18. The non-transitory computer-readable storage medium of claim 17, wherein the one or more processors execute the instructions to: identify a current location of the acoustic device; identify that a velocity of the acoustic device should be reduced based on a deployment profile and the current location of the device; and initiate at least one of the one or more control functions to reduce the velocity of the acoustic device based on the deployment profile.

19. The non-transitory computer-readable storage medium of claim 18, wherein the one or more processors execute the instructions to identify a time difference associated with movement of the acoustic device from a first wellbore feature to a second wellbore feature; and identify the velocity of the acoustic device based on the time difference and a distance separating the first wellbore feature and the second wellbore feature.

20. The non-transitory computer-readable storage medium of claim 15, wherein the one or more processors execute the instructions to identify that a portion of the data associated with the acoustic wave reflections matches a pattern indicative of a wellbore feature located at the target location.
